(19) United States
(12) Patent Application Publication
(10) Pub. No.: US 2004/0173441 A1
(43) Pub. Date: Sep. 9, 2004

(54) Roller top conveyor chain assembly

(76) Inventors: Dean A. Wieting, Milwaukee, WI (US); Paul M. Koeferl, Brown Deer, WI (US)

Correspondence Address: QUARLES & BRADY LLP, 411 E. WISCONSIN AVENUE, SUITE 2040, MILWAUKEE, WI, 53202-4497, US

(21) Appl. No.: 10/790,484

(22) Filed: Mar. 1, 2004

Related U.S. Application Data
(60) Provisional application No. 60/451,565, filed on Mar. 3, 2003.

(51) Int. Cl. B65G 17/06

(52) U.S. Cl. 198/850; 198/845

(57) ABSTRACT

A roller top conveyor chain assembly includes a first strand of conveyor chain formed from a plurality of first link assemblies. A second strand of conveyor chain is formed from a plurality of second link assemblies. The second strand of conveyor chain is substantially parallel to the first strand of conveyor chain for cooperatively conveying an object with the first strand of conveyor chain. A first roller support frame extends between one of the first link assemblies of the plurality of first link assemblies and one of the second link assemblies of the plurality of second link assemblies. The roller support frame includes a top wall having at least one upwardly opening cavity formed therein. A roller is rotatably mounted in the cavity for supporting the object being conveyed by the first and second strands of conveyor chain.

### CROSS REFERENCES TO RELATED APPLICATIONS

This application claims the priority benefit of U.S. Provisional Patent Application No. 60/451,565 filed on Mar. 3, 2003.

### STATEMENT REGARDING FEDERALLY SPONSORED RESEARCH

Not Applicable.

### BACKGROUND OF THE INVENTION

This invention relates to roller top conveyor chains, and more particularly to a conveyor chain assembly comprising two or more strands of chain supporting a roller therebetween.

Engineered chain typically comprises pivotally linked chain link assemblies that are driven by a sprocket to convey materials. The chain link assemblies can directly support a product being conveyed or include a top plate that engages the products being conveyed.

Engineered conveyor chains can transport products in the direction of conveyor travel, but have difficulty transferring a product, especially a high friction product, onto and off of the chain in a direction other than the direction of travel. Moreover, high friction products can easily damage the chain if the product is transferred onto the chain from a direction other than the chain direction of travel or the product conveyed encounters an obstruction creating a back pressure. In addition, accumulation of a product on a high friction surface of the chain can easily damage the chain or product being conveyed.

### BRIEF SUMMARY OF THE INVENTION

The present invention provides a roller top conveyor chain assembly that solves the above problems. The assembly includes a first strand of conveyor chain formed from a plurality of first link assemblies. A second strand of conveyor chain is formed from a plurality of second link assemblies. The second strand of conveyor chain is substantially parallel to the first strand of conveyor chain for cooperatively conveying an object with the first strand of conveyor chain. A first roller support frame extends between one of the first link assemblies of the plurality of first link assemblies and one of the second link assemblies of the plurality of second link assemblies. The roller support frame includes a top wall having at least one upwardly opening cavity formed therein. A roller is rotatably mounted in the cavity for supporting the object being conveyed by the first and second strands of conveyor chain.

A general objective of the present invention is to provide a conveyor chain assembly that can convey high friction objects without severely damaging the objects or the conveyor chain assembly. This objective is accomplished by supporting a roller support frame between a pair of parallel strands of chain, wherein the roller support frame supports at least one roller that reduces friction between the object and the conveyor chain assembly.

The foregoing and other objectives and advantages of the invention will appear from the following description. In the description, reference is made to the accompanying drawings which form a part hereof, and in which there is shown by way of illustration a preferred embodiment of the invention.

### BRIEF DESCRIPTION OF THE DRAWINGS

FIG. 1 is a perspective and partially exploded view of a roller top conveyor chain assembly incorporating the present invention;

FIG. 2 is a perspective and partially exploded view of second embodiment of a roller top conveyor chain assembly incorporating the present invention;

FIG. 3 is a perspective and partially exploded view of a third embodiment of a roller top conveyor chain assembly incorporating the present invention;

FIG. 4 is a perspective and partially exploded view of a fourth embodiment of a roller top conveyor chain assembly incorporating the present invention; and

FIG. 5 is a perspective and partially exploded view of a fifth embodiment of a roller top conveyor chain assembly incorporating the present invention.

### DETAILED DESCRIPTION OF THE PREFERRED EMBODIMENTS

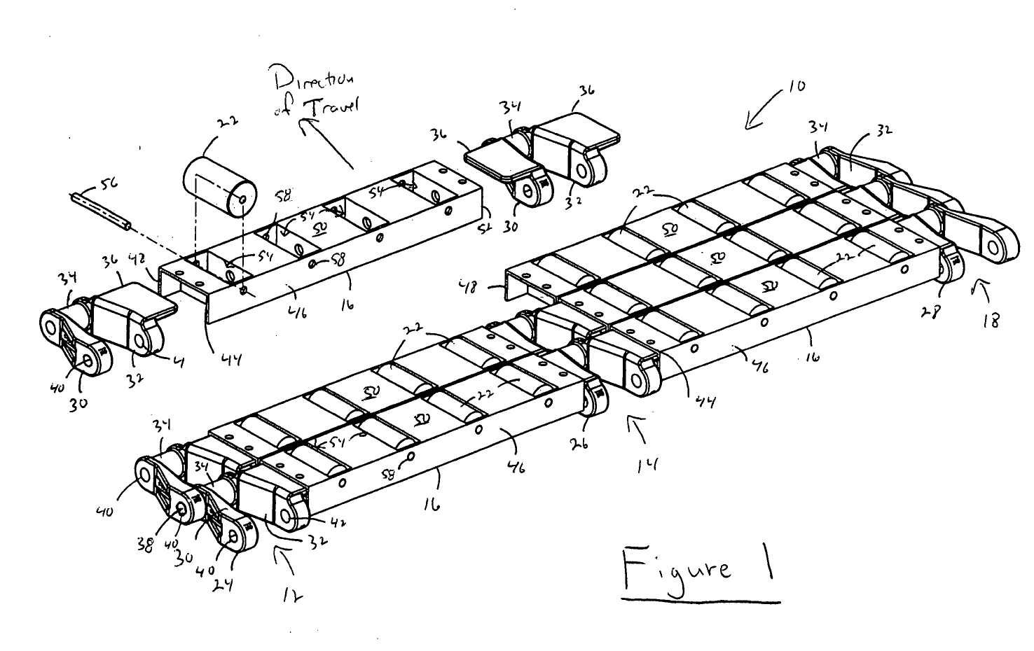

As shown in FIG. 1, a roller top conveyor chain assembly 10 includes first and second strands 12, 14 of engineered conveyor chain. The first and second strands 12, 14 are substantially parallel, and support a roller support frame 16 therebetween. A third strand 18 of engineered chain can be provided that is substantially parallel to the first and second strands 12, 14 of chain with another roller support frame 16 supported between the second and third strands 14, 18 of chain. Cylindrical rollers 22 mounted in the frames 16 allow low friction transverse movement of a product supported by the chain assembly 10 for transferring a product onto and off of the chain assembly 10 in a direction not parallel to the direction of conveyor travel.

Each strand 12, 14, 18 of chain forms an endless loop comprising a plurality of chain link assemblies 24, 26, 28, respectively. In one embodiment, the basic structure of each strand 12, 14, 18 of chain is substantially similar to Rexnord NH78 Engineered Driven Chain available from Rexnord Industries, Inc. in Milwaukee, Wis.

Each chain link assembly 24, 26, 28 is pivotally linked to an adjacent chain link assembly 24, 26, 28, and includes a pair of spaced side arms 30, 32 or bars extending from the ends of an integral cylindrical barrel 34, a flight 36 extending from at least one of the side arms 30, 32, and a connecting pin 38. Distal ends of the side arms 30, 32 include apertures 40, 42 that are aligned with the barrel 34 received therebetween of an adjacent chain link assembly 24, 26, 28. The connecting pin 38 is received through the apertures 40, 42 and barrel 34 of the adjacent chain link assembly 24, 26, 28 to pivotally link the chain link assembly 24, 26, 28 to the respective adjacent chain link assembly 24, 26, 28.

Each flight 36 supports one of the first and second ends 44, 52 of one of the roller support frames 16 extending between adjacent strands 12, 14, 18 of chain. Preferably, the flight 36 is formed as an integral part of the side arm 30, 32 facing the adjacent strand 12, 14, 18 of chain. As shown in FIG. 1, the chain link assemblies 26 forming the second strand 14 of chain have a flight 36 extending from each side arm 30, 32, while the chain link assemblies 24, 28 forming the first and third strands 12, 18 of chain have only one flight 36 extending from the side arm 30, 32 facing the second strand 14 of chain.

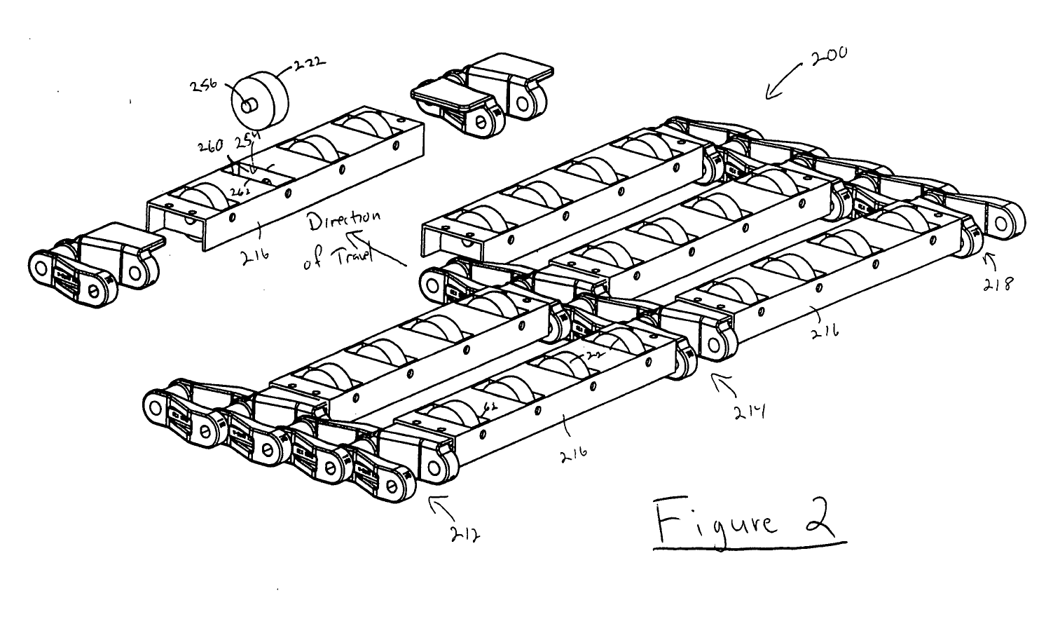

Although each chain link assembly forming the strands of chain include at least one flight, the strands of chain can include chain link assemblies that do not have flights or support a roller support frame, such as shown in FIGS. 2-4, without departing from the scope of the invention. Moreover, although the chain link assemblies 24, 28 forming the first and third strands 12, 18 of chain are shown to have only one flight 36, the first and third strands 12, 18 of chain can be formed using the chain link assemblies 26 forming the second strand 14 of chain without departing from the scope of the invention. Of course, if only two strands of chain are used only the chain link assemblies 24, 28 forming the first and third strands 12, 18 of chain are required, while if more than three strands of chain are used, two or more strands of chain can be formed from the chain link assemblies 26 forming the second strand 14 of chain.

Each roller support frame 16 is supported between adjacent strands 12, 14, 18 of chain, and rotatably supports one or more of the rollers 22 that engage the object being conveyed. The roller support frame 16 is supported at the first end 44 by the flight 36 of one chain link assembly 24 forming part of the first strand 12 of chain, and is supported at the second end 52 by the flight 36 of the chain link assembly 26 forming part of the second strand 14 of chain. The ends 44, 52 are fixed to the respective flights 36 using methods known in the art, such as fasteners including pins, rivets, screws, welding, friction fits, chemical bonding including adhesives, snap fit, and the like.

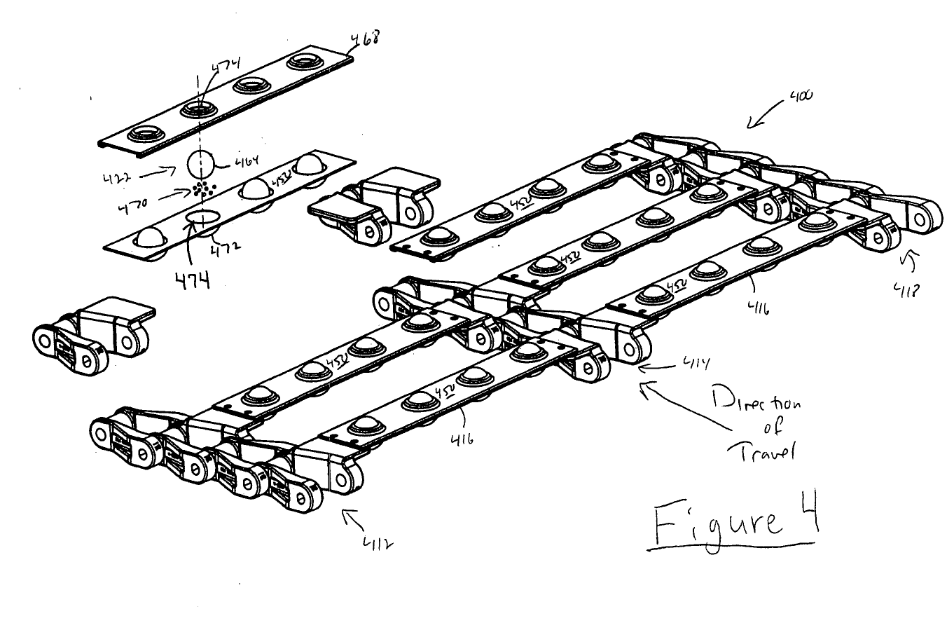

In the embodiment disclosed in FIG. 1, each roller support frame 16 includes a front wall 46 and a rear wall 48 joined by a top wall 50 to form a U-shaped channel. The roller support frame 16 can be formed from plastic, metal, and the like, using methods known in the art, such as molding, stamping, and the like. Cavities 54 formed in the top wall of each roller support frame 16 receive the rollers 22 that engage the product being conveyed. The cavities 54 shown in FIG. 1 have an open bottom, however, the cavities can have a closed bottom, such as shown in FIG. 4 without departing from the scope of the invention. Advantageously, cavities 54 in line between support frames 16 of adjacent support frames 16 in the direction of travel allows spaces between cavities 54 for engaging a guide rail (not shown) that supports the chain assembly 10 when returning from one end of the conveyor to the other in the endless loop. Of course, the cavities can be staggered between adjacent support frames without departing from the scope of the invention.

Each roller 22 is rotatably supported in one of the cavities 54, and is engageable with the object being conveyed to reduce friction between the object and the conveyor chain assembly 10. An axle 56, formed from any suitable material, such as metal, plastic, and the like, extending through each cavity 54 rotatably supports the roller 22 in the cavity, and defines an axis of rotation of the roller 22. Opposing ends of the axle 56 are rotatably mounted in apertures 58 formed in the front and rear walls 46, 48 of the roller support frame 16 to align the axle 56 in the direction of travel of the strands 12, 14, 18 of the chain (i.e. the axis of rotation defines an angle with the direction of travel of approximately 0°). Advantageously, aligning the axle in the direction of travel of the strands of chain allows low friction loading and unloading of the objects onto the conveyor chain assembly from a direction that defines an angle with the strands of chain, such as 90 degrees. Of course, the roller axle can be oriented in the cavity at any angle greater than 0° relative to the strands of chain, and thus the direction of travel, to allow loading and unloading objects onto the conveyor chain assembly from any direction without departing from the scope of the invention.

In use, the roller chain assembly 10 is driven by rotatably driven sprockets (not shown) that engage each strand 12, 14, 18 of chain, as is known in the art. The rollers engage the objects being conveyed, and provide low friction loading and unloading of the objects transverse to the direction of travel of the conveyor chain assembly to minimize damage of the objects and conveyor chain assembly.

In a second embodiment disclosed in FIG. 2, a low back pressure roller top conveyor chain assembly 200 includes strands 212, 214, 218 of chain having roller support frame 216 extending therebetween, such as described above. Cavities 254 formed in the roller support frames 216 receive rollers 222 for supporting product being conveyed. Each roller 222 is rotatably mounted in one of the cavities 254 by an axle 256 rotatably mounted in vertical walls 260 extending downwardly from each cavity side edge 262. Advantageously, in the second embodiment, each axle 256 defines an axis of rotation that is substantially perpendicular to the direction of travel of the strands 212, 214, 218 of chain (i.e. defines an angle with the direction of travel of approximately 90°) to form the low back pressure conveyor chain assembly 200.

In the embodiment disclosed in FIG. 2, the axle 256 is formed as an integral part of the roller 222. However, the axle 256 can be formed independent of the roller 222, can be stubs extending into the roller sides, and the like, without departing from the scope of the invention.

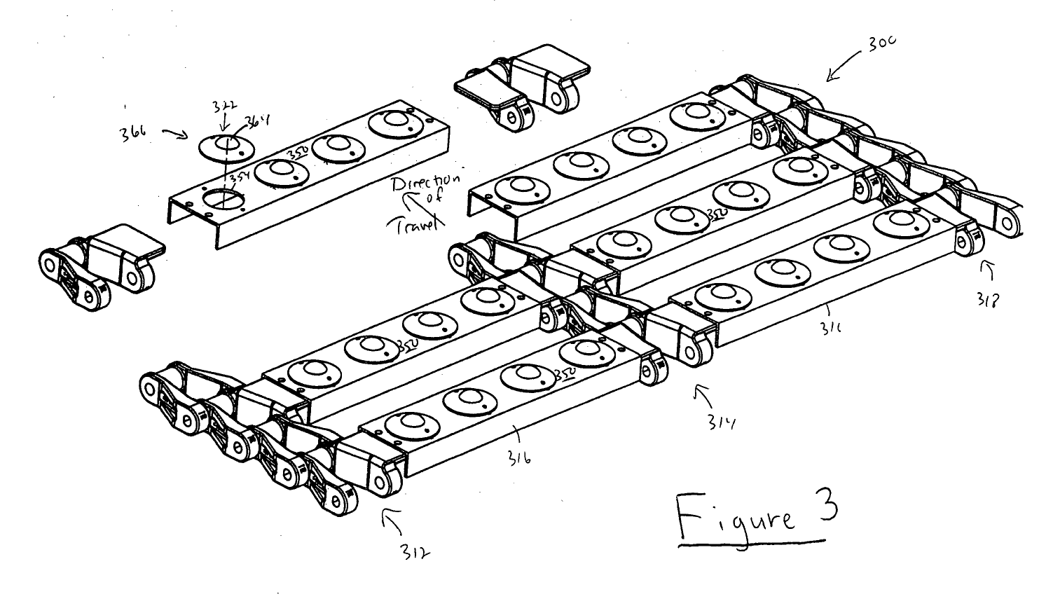

In a third embodiment disclosed in FIG. 3, a roller top conveyor chain assembly 300 includes strands 312, 314, 318 of chain having roller support frames 316 extending therebetween, such as described above. Cavities 354 formed in the roller support frames 316 receives rollers 322 for supporting product being conveyed. Each roller 322 is a ball 364 formed from any suitable material, such as metal, plastic, rubber, and the like, and forming part of a roller ball assembly 366. Commercially available transfer/roller ball assemblies, such as high profile, low profile, swivel roller, and the like assemblies available from Alwayse Engineering Limited in Birmingham, England can be used depending upon the particular application of the conveyor chain assembly.

Each roller ball assembly 366 is received in one of the cavities 354 formed in a roller support frame top wall 350 of at least one of the roller support frames 316, and is secured to the top wall 350 using methods known in the art, such as described above including fasteners, adhesives, friction fit, snap fit, and the like without departing from the scope of the invention. Advantageously, using roller ball assemblies does not limit the direction of rotation of the roller, thus allowing loading and unloading objects onto the conveyor chain assembly from any direction while maintaining low back pressure properties. Although receiving the roller ball assembly in one of the cavities is preferred, the roller ball assembly can be mounted relative to the top wall.

In a fourth embodiment disclosed in FIG. 4, a roller top conveyor chain assembly 400 includes strands 412, 414, 418 of chain having roller support frames 416 extending therebetween, such as described above. Cavities 454 formed in the roller support frames 416 receives rollers 422 for supporting product being conveyed. Each roller 422 is a ball 464 received in one of the cavities 454 formed in a top wall 450 of at least one of the roller support frames 416. Each cavity 454 has a closed bottom 472 to support the ball 464 received therein. A retaining plate 468 retains the balls 464 in the respective cavities 454. Ball bearings 470 can be provided in each cavity 454 to reduce the friction between the ball 464 and the cavity 454.

The retaining plate 468 is fixed to the top wall 450 using methods known in the art, such as described above including fasteners, welding, friction fits, chemical bonding, snap fit, crimping, and the like. Apertures 474 formed through the retaining plate 468 are aligned with the cavities 454 formed in the top wall 450. The retaining plate apertures 474 have a diameter that is smaller than the ball diameter to retain the ball 464 in the top wall cavity 454. As in the third embodiment, rollers in the form of balls do not limit the direction of rotation of the roller, thus allowing loading and unloading objects onto the conveyor chain assembly from any direction while maintaining low back pressure properties.

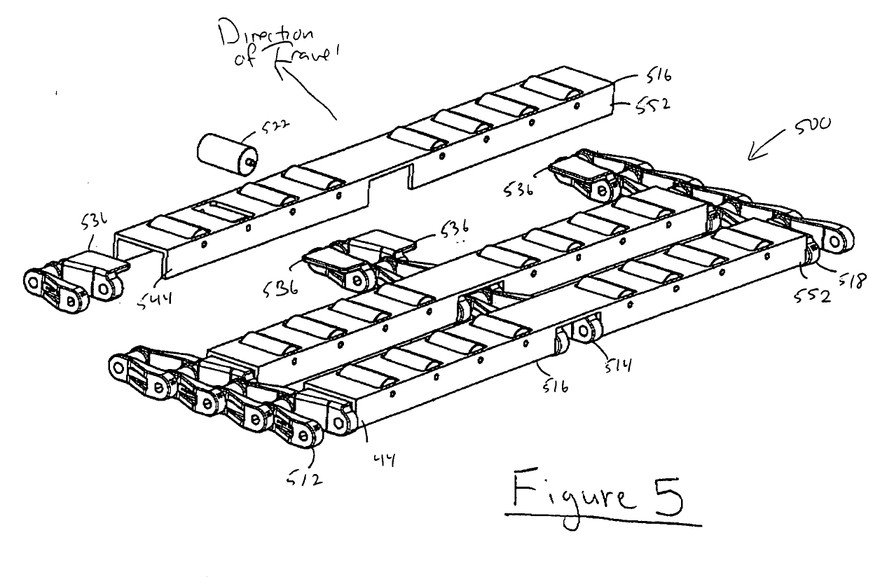

In yet another embodiment disclosed in FIG. 5, a roller top conveyor chain assembly 500 includes strands 512, 514, 518 of chain having roller support frames 516 extending therebetween which supports rollers 522, such as described above. First and second strands 512, 518 of parallel engineered chain 512, 518 support opposing ends 544, 552 of the roller support frame 516. A third strand 514 of chain parallel to and between the first and second strands 512, 518 of chain support the roller support frame 516 between the roller support frame opposing ends 544, 552. Chain link assemblies 526 forming the third strand 514 of chain can include flights 536 that are attached to the roller support frame 516.

While there have been shown and described what is at present considered the preferred embodiments of the invention, it will be obvious to those skilled in the art that various changes and modifications can be made therein without departing from the scope of the invention defined by the appended claims.

We claim:

1. A roller top conveyor chain assembly comprising:
a first strand of conveyor chain formed from a plurality of first link assemblies;
a second strand of conveyor chain formed from a plurality of second link assemblies, said second strand of conveyor chain being substantially parallel to said first strand of conveyor chain for cooperatively conveying an object with said first strand of conveyor chain;
a first roller support frame extending between one of said first link assemblies of said plurality of first link assemblies and one of said second link assemblies of said plurality of second link assemblies, said roller support frame including a top wall having at least one upwardly opening cavity formed therein;
a roller rotatably mounted in said cavity for engaging the object being conveyed by said first and second strands of conveyor chain.

2. The roller top conveyor chain assembly as in claim 1, in which a first end of said first roller frame is fixed to said one of said first link assemblies, and a second end of said first roller frame is fixed to said one of said second link assemblies.

3. The roller top conveyor chain assembly as in claim 2, in which said one of said first link assemblies includes a flight extending toward said one of said second link assemblies, and said first end of said first roller frame is fixed to said flight.

4. The roller top conveyor chain assembly as in claim 1, including a third strand of conveyor chain formed from a plurality of third link assemblies, said third strand of conveyor chain being substantially parallel to said second strand of conveyor chain for cooperatively conveying the object with said first and second strands of conveyor chain, and a second roller support frame extending between one of said third link assemblies of said plurality of third link assemblies and one of said second link assemblies of said plurality of second link assemblies, said roller support frame including a top wall having at least one upwardly opening cavity formed therein, and a roller rotatably mounted in said cavity formed in said top wall of said second roller support frame for supporting the object being conveyed by said first, second, and third strands of conveyor chain.

5. The roller top conveyor chain assembly as in claim 4, in which said one of said second link assemblies includes a first flight extending toward said one of said first link assemblies and a second flight extending toward said one of said third link assemblies, and a first end of said first roller frame is fixed to said first flight and a first end of said second roller frame is fixed to said second flight.

6. The roller top conveyor chain assembly as in claim 1, in which said roller includes an axis of rotation, and said axis of rotation is parallel to said second strand of conveyor chain.

7. The roller top conveyor chain assembly as in claim 1, in which said roller is a ball.

8. The roller top conveyor chain assembly as in claim 7, in which said ball forms part of a roller ball assembly fixed to said first roller support frame.

9. The roller top conveyor chain assembly as in claim 1, in which said roller includes an axis of rotation, and said axis of rotation defines an angle that is greater than 0 degrees with said second strand of conveyor chain.

10. The roller top conveyor chain assembly as in claim 9, in which said angle is approximately 90 degrees to form a low back pressure conveyor chain assembly.

11. The roller top conveyor chain assembly as in claim 1, including a third strand of conveyor chain formed from a plurality of third link assemblies, said third strand of conveyor chain being substantially parallel to and between said first and second strands of conveyor chain for cooperatively conveying the object with said first and second strands of conveyor chain.

12. A roller top conveyor chain assembly comprising:
a first strand of conveyor chain formed from a plurality of first link assemblies, at least one of said link assemblies including a flight;
a second strand of conveyor chain formed from a plurality of second link assemblies, said second strand of conveyor chain being substantially parallel to said first strand of conveyor chain for cooperatively conveying an object with said first strand of conveyor chain, and at least one of said second link assemblies including a flight;
a first roller support frame extending between said flight of said first link assemblies of said plurality of first link assemblies and said flight of said second link assemblies of said plurality of second link assemblies, said roller support frame including a top wall;
a roller rotatably mounted relative to said top wall for engaging the object being conveyed by said first and second strands of conveyor chain.

13. The roller top conveyor chain assembly as in claim 12, including a third strand of conveyor chain formed from a plurality of third link assemblies, said third strand of conveyor chain being substantially parallel to said second strand of conveyor chain for cooperatively conveying the object with said first and second strands of conveyor chain, and a second roller support frame extending between one of said third link assemblies of said plurality of third link assemblies and one of said second link assemblies of said plurality of second link assemblies, said roller support frame including a top wall having at least one upwardly opening cavity formed therein, and a roller rotatably mounted in said cavity formed in said top wall of said second roller support frame for supporting the object being conveyed by said first, second, and third strands of conveyor chain.

14. The roller top conveyor chain assembly as in claim 12, in which said roller includes an axis of rotation, and said axis of rotation is parallel to said second strand of conveyor chain.

15. The roller top conveyor chain assembly as in claim 12, in which said roller is a ball.

16. The roller top conveyor chain assembly as in claim 15, in which said ball forms part of a roller ball assembly fixed to said first roller support frame.

17. The roller top conveyor chain assembly as in claim 12, in which said roller includes an axis of rotation, and said axis of rotation defines an angle that is greater than 0 degrees with said second strand of conveyor chain.

18. The roller top conveyor chain assembly as in claim 17, in which said angle is approximately 90 degrees to form a low back pressure conveyor chain assembly.

19. The roller top conveyor chain assembly as in claim 12, including a third strand of conveyor chain formed from a plurality of third link assemblies, said third strand of conveyor chain being substantially parallel to and between said first and second strands of conveyor chain for cooperatively conveying the object with said first and second strands of conveyor chain.
